(19) United States
(12) Patent Application Publication
(10) Pub. No.: US 2025/0232590 A1
(43) Pub. Date: Jul. 17, 2025

(54) INFORMATION PROCESSING DEVICE, IMAGING DEVICE, AND INFORMATION PROCESSING METHOD

(71) Applicant: JVCKENWOOD Corporation, Yokohama-shi (JP)

(72) Inventor: Yasutoshi Sakai, Yokohama-shi, Kanagawa (JP)

(21) Appl. No.: 19/096,771

(22) Filed: Apr. 1, 2025

Related U.S. Application Data
(63) Continuation of application No. PCT/JP2023/036066, filed on Oct. 3, 2023.

(30) Foreign Application Priority Data
Oct. 4, 2022 (JP) 2022-160276
Oct. 4, 2022 (JP) 2022-160395

(51) Int. Cl. G06V 20/52; G06V 20/58; G06V 40/10; H04N 23/661; H04N 23/90

(52) U.S. Cl. CPC G06V 20/52; G06V 20/58; G06V 40/10; H04N 23/661; H04N 23/90

(57) ABSTRACT

An information processing device includes a location information obtaining unit that, from each of a plurality of imaging devices which is used in a mobile object and which searches for an object, obtains location information indicating the current location of the imaging device; and a deciding unit that, based on the location information of each of the plurality of imaging devices, decides on the imaging device to be used in searching for the object.

### CROSS-REFERENCE TO RELATED APPLICATIONS

This application is a Continuation of PCT International Application No. PCT/JP2023/036066 filed on Oct. 3, 2023 which claims the benefit of priority from Japanese Patent Applications No. 2022-160276 and No. 2022-160395, both filed on Oct. 4, 2022, the entire contents of all of which are incorporated herein by reference.

### BACKGROUND OF THE INVENTION

### 1. Field of the Invention

The application concerned is related to an information processing device, an imaging device, and an information processing method.

### 2. Description of the Related Art

A technology is known that detects persons captured in an image that is taken by an in-vehicle camera. For example, in Japanese Patent Application Laid-open No. 2020-95357 is disclosed a technology that detects the behavior of the persons captured in an image that is taken by an in-vehicle camera, and evaluates the behavior of those persons.

In a system in which a plurality of in-vehicle cameras and a server are used, it is assumed that a search is carried out for a search target such as a person. In that case, for each of a plurality of in-vehicle cameras, the search target is desirably decided in such a way that the processing load of the in-vehicle cameras can be reduced.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

An information processing device according to the present disclosure comprising: a location information obtaining unit that, from each of a plurality of imaging devices which searches for an object, obtains location information indicating current location of the imaging device; and a deciding unit that, based on the location information of each of the plurality of imaging devices, decides on the imaging device to be used in searching for the object.

An imaging device that is used in a mobile object, according to the present disclosure comprising:
an imaging unit; a search information obtaining unit that, from an information processing device, obtains search information containing information related to an object to be searched and location information of imaging devices used in other mobile objects searching for the object; a deciding unit that, based on the search information, decides on whether or not to search for the object; and a detecting unit that, from an image taken by the imaging unit, detects the object that is decided to be search target by the deciding unit.

An information processing method according to the present disclosure comprising: obtaining, from each of a plurality of imaging devices which searches for an object, location information indicating current location of the imaging device; and deciding, based on the location information of each of the plurality of imaging devices, the imaging device to be used in searching for the object.

### BRIEF DESCRIPTION OF THE DRAWINGS

FIG. 1 is a diagram for explaining an exemplary configuration of a search system according to a first embodiment;

FIG. 2 is a diagram for explaining the overview of an imaging device according to the first embodiment;

FIG. 3 is a diagram for explaining an exemplary configuration of an information processing device according to the first embodiment;

FIG. 4 is a block diagram illustrating an exemplary configuration of the imaging device according to the first embodiment;

FIG. 5 is a flowchart for explaining the operation details of the information processing device according to the first embodiment;

FIG. 6 is a diagram for explaining a method for deciding on the imaging devices to be used in searching for an object according to the first embodiment;

FIG. 7 is a flowchart for explaining the operation details of the imaging device according to the first embodiment;

FIG. 8 is a flowchart for explaining the operation details of an information processing device according to a second embodiment;

FIG. 9 is a flowchart for explaining the operation details of an information processing device according to a third embodiment;

FIG. 10 is a flowchart for explaining the operation details of an information processing device according to a fourth embodiment;

FIG. 11 is a diagram for explaining a method for setting the objects for the imaging devices according to the fourth embodiment;

FIG. 12 is a diagram for explaining a first method for deciding on the imaging devices to be used in searching for the objects according to the fourth embodiment;

FIG. 13 is a diagram for explaining a second method for deciding on the imaging devices to be used in searching for the objects according to the fourth embodiment;

FIG. 14 is a flowchart for explaining the operation details of an information processing device according to a fifth embodiment;

FIG. 15 is a diagram for explaining an exemplary configuration of an information processing device according to a sixth embodiment;

FIG. 16 is a block diagram illustrating an exemplary configuration of an imaging device according to the sixth embodiment;

FIG. 17 is a flowchart for explaining the operation details of the information processing device according to the sixth embodiment; and

FIG. 18 is a flowchart for explaining the operation details of the imaging device according to the sixth embodiment.

### DETAILED DESCRIPTION OF THE PREFERRED EMBODIMENTS

Exemplary embodiments of the application concerned are described below in detail with reference to the accompanying drawings. However, the application concerned is not limited by the embodiments described below. Moreover, in the embodiments described below, identical constituent elements are referred to by the same reference numerals, and their explanation is not given repeatedly.

### First Embodiment

### Search System

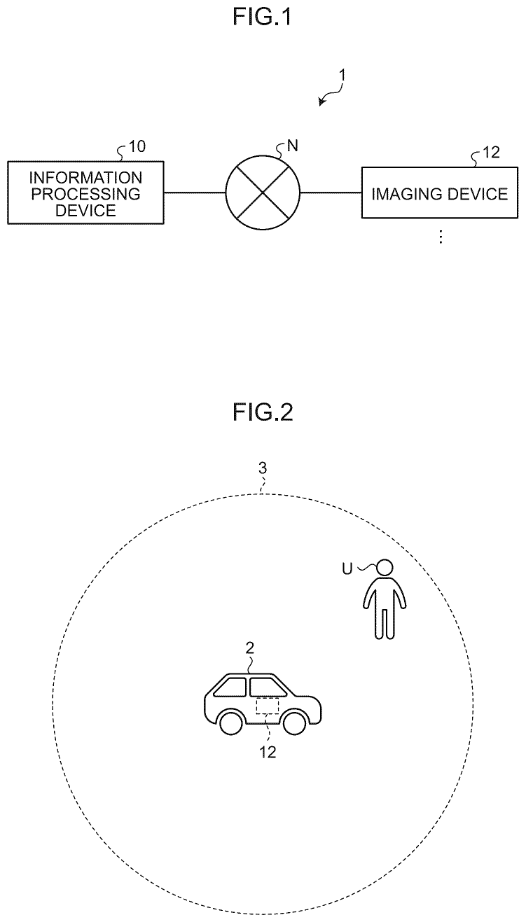

Explained below with reference to FIG. 1 is an exemplary configuration of a search system according to a first embodiment. FIG. 1 is a diagram for explaining an exemplary configuration of the search system according to the first embodiment.

As illustrated in FIG. 1, a search system 1 includes an information processing device 10 and a plurality of imaging devices 12. The information processing device 10 is communicably connected to the imaging devices 12 via a network N. In the search system 1, the information processing device 10 decides on the objects that are to be searched by the imaging devices 12, and the imaging devices 12 search for the objects.

Explained below with reference to FIG. 2 is the overview of the imaging device according to the first embodiment. FIG. 2 is a diagram for explaining the overview of the imaging device according to the first embodiment.

As illustrated in FIG. 2, the imaging device 12 can be an in-vehicle camera installed in a vehicle 2. For example, the imaging device 12 can be implemented using a drive recorder that is installed in the vehicle 2 and that takes images of the surrounding of the vehicle 2. For example, the imaging device 12 takes images within a predetermined range 3 around the vehicle 2. Meanwhile, the imaging device 12 is not limited to be installed in the vehicle 2, and can be installed in any mobile object. Alternatively, the imaging device 12 can be installed in a mobile terminal that is portable by a person. Thus, as long as the imaging device 12 is used in a mobile object, it serves the purpose. For example, based on a taken image, the imaging device 12 detects objects (for example, a person U) specified by the information processing device 10. The person U is, for example, a search target including a missing person. Examples of the object to be searched include, but are not limited to, a person, a vehicle, an animal such as a pet, or a lost object.

The information processing device can specify a plurality of objects that are to be searched by the imaging device 12. As the number of objects to be searched increases, the processing load of the imaging device 12 goes on increasing. Accompanying such an increase in the processing load of the imaging device 12, there is a possibility that the imaging device 12 becomes unable to detect the objects due to a decline in the processing speed, and that the power consumption of the imaging device 12 increases. Moreover, accompanying an increase in the number of imaging devices 12 to be used in searching for the objects, there is a possibility that the processing load of the entire search system 1 increases and the time required for the search increases. In that regard, in the first embodiment, in order to reduce the processing load of the search system 1, an operation is performed for deciding on the imaging devices that, from among a plurality of imaging devices 12, are to be used in searching for the objects.

### Information Processing Device

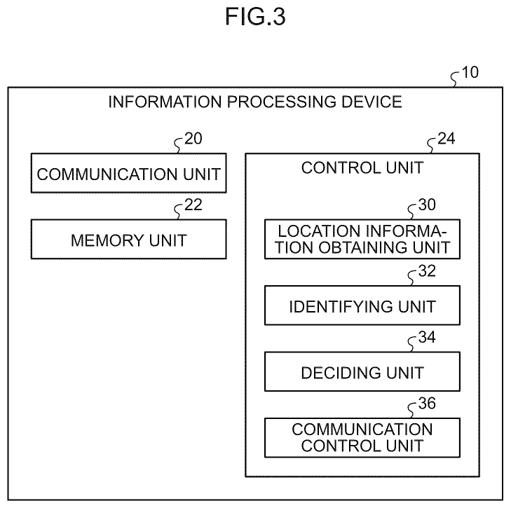

Explained below with reference to FIG. 3 is an exemplary configuration of an information processing device according to the first embodiment. FIG. 3 is a diagram for explaining an exemplary configuration of the information processing device according to the first embodiment.

As illustrated in FIG. 3, the information processing device 10 includes a communication unit 20, a memory unit 22, and a control unit 24. The information processing device 10 can be implemented using, for example, a server device installed at the control center of the search system 1.

The communication unit 20 is a communication interface for enabling communication with external devices. For example, the communication unit 20 enables communication between the information processing device 10 and the imaging devices 12.

The memory unit 22 is used to store a variety of information. The memory unit 22 is used to store the computation details of the control unit 24 and to store the information such as computer programs. The memory unit 22 includes, for example, at least either a main memory device such as a random access memory (RAM) or a read only memory (ROM), or an external storage device such as a hard disk drive (HDD).

The memory unit 22 is used to store object information about the objects to be searched. In the memory unit 22, the information that is required by the imaging devices 12 for detecting objects from images is stored as the object information. For example, the object information can be still image data and video data of the objects. When an object is a person, for example, the object information can indicate the gender, the age, the hairstyle, the clothing including a bag and a cap, the facial feature quantity, the belongings such as glasses and a walking stick, the height, the body type, and the gait of the person to be searched. For example, the object information can be externally input by the user of the search system 1.

The control unit 24 controls the constituent elements of the information processing device 10. The control unit 24 includes, for example, an information processing device such as a central processing unit (CPU) or a micro processing unit (MPU), and a memory device such as a random access memory (RAM) or a read only memory (ROM). The control unit 24 executes a computer program meant for controlling the operations of the information processing device 10 according to the application concerned. Alternatively, for example, the control unit 24 can be implemented using an integrated circuit such as an application specific integrated circuit (ASIC) or a field programmable gate array (FPGA). Still alternatively, the control unit 24 can be implemented using a combination of hardware and software.

The control unit 24 includes a location information obtaining unit 30, an identifying unit 32, a deciding unit 34, and a communication control unit 36.

The location information obtaining unit 30 obtains, from each imaging device 12 via the communication unit 20, location information indicating the current location of that imaging device 12.

The identifying unit 32 identifies the object representing the search target for the imaging devices 12. For example, the identifying unit 32 identifies an object based on the information input by the user of the search system 1 using an external device. Herein, the identifying unit 32 either can identify a single object or can identify a plurality of objects. On the other hand, the identifying unit 32 need not identify even a single object.

The deciding unit 34 decides on the imaging device 12 that, from among a plurality of imaging devices 12, is to be used in searching for the object identified by the identifying unit 32. For example, based on the location information of the imaging devices 12 as obtained by the location information obtaining unit 30, the deciding unit 34 decides on the imaging device 12 to be used in searching for the object identified by the identifying unit 32. Then, to the decided imaging device 12, the deciding unit 34 sends the object information via the communication unit 20 and specifies the object to be searched.

The communication control unit 36 controls the communication unit 20 and thus controls the communication between the information processing device 10 and the external devices. For example, the communication control unit 36 controls the communication between the information processing device 10 and the imaging devices 12.

### Imaging Device

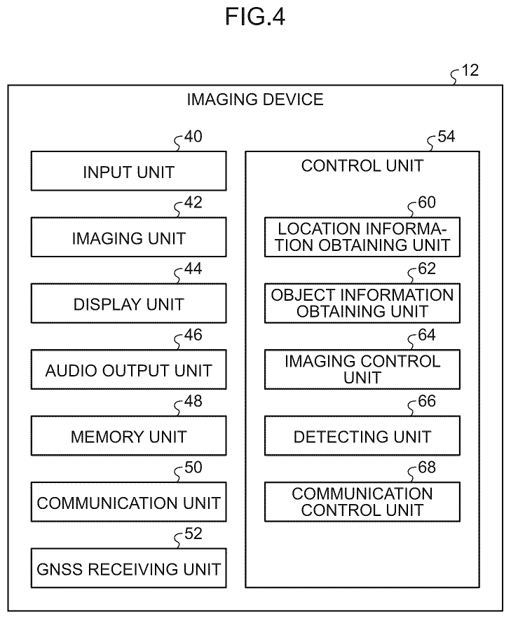

Explained below with reference to FIG. 4 is an exemplary configuration of the imaging device according to the first embodiment. FIG. 4 is a block diagram illustrating an exemplary configuration of the imaging device according to the first embodiment.

As illustrated in FIG. 4, the imaging device 12 includes an input unit 40, an imaging unit 42, a display unit 44, an audio output unit 46, a memory unit 48, a communication unit 50, a GNSS receiving unit 52 (GNSS stands for Global Navigation Satellite System), and a control unit 54.

The input unit 40 receives various operations performed with respect to the imaging device 12. The input unit 40 is implemented using a microphone, a switch, a button, or a touch-sensitive panel.

The imaging unit 42 takes images. The imaging unit 42 is installed to be able to take images of the surrounding of the vehicle 2. For example, the imaging unit 42 takes images of the anterior side of the vehicle 2. The imaging device 12 can include a plurality of imaging units 42 that takes images of the anterior side, the posterior side, and the lateral sides of the vehicle 2. For example, the imaging unit 42 takes still images or videos. The imaging unit 42 can be, for example, a camera including an optical device and an imaging device. Alternatively, the imaging unit 42 can be, for example, a visible light camera or an infrared camera.

The display unit 44 displays various images. For example, the display unit 44 is a liquid crystal display or a display including organic electro-luminescence (EL).

The audio output unit 46 is a speaker that outputs various audios.

The memory unit 48 is used to store a variety of information. The memory unit 48 is used to store the computation details of the control unit 54 and to store the information such as computer programs. The memory unit 22 includes, for example, at least either a main memory device such as a RAM or a ROM, or an external storage device such as an HDD.

The communication unit 50 is a communication interface for enabling communication between the imaging device 12 and external devices. For example, the communication unit 50 enables communication between the imaging device 12 and the information processing device 10.

The GNSS receiving unit 52 is configured with a GNSS receiver that receives GNSS signals from a GNSS satellite. The GNSS receiving unit 52 outputs the received GNSS signals to a location information obtaining unit 60.

The control unit 54 controls the constituent elements of the imaging device 12. The control unit 54 includes, for example, an information processing device such as a CPU or an MPU, and a memory device such as a RAM or a ROM. The control unit 54 executes a computer program meant for controlling the operations of the imaging device 12 according to the application concerned. Alternatively, for example, the control unit 54 can be implemented using an integrated circuit such as an ASIC or an FPGA. Still alternatively, the control unit 54 can be implemented using a combination of hardware and software.

The control unit 54 includes a location information obtaining unit 60, an object information obtaining unit 62, an imaging control unit 64, a detecting unit 66, and a communication control unit 68.

The location information obtaining unit 60 obtains the current-location information of the vehicle 2 in which the imaging device 12 is installed. Based on the GNSS signals received by the GNSS receiving unit 52, the location information obtaining unit 60 obtains the current-location information of the vehicle. Moreover, the location information obtaining unit 60 can obtain the current-location information further based on the information about a vehicle speed sensor (not illustrated).

The object information obtaining unit 62 obtains, from the information processing device 10 via the communication unit 50, object information related to the objects to be searched.

The imaging control unit 64 controls the imaging unit 42 and causes the imaging unit 42 to take images of the surrounding of the vehicle 2. Then, the imaging control unit 64 obtains the images, which are taken by the imaging unit 42, from the imaging unit 42.

The detecting unit 66 detects an object from an image that is obtained by the imaging control unit 64 from the imaging unit 42. For example, the detecting unit 66 performs image recognition with respect to an image obtained by the imaging control unit 64 from the imaging unit 42, and detects the object that is indicated by the object information obtained by the object information obtaining unit 62. For example, the detecting unit 66 detects the object using the information such as the still image data, the facial feature quantity, and the clothing specified in the object information. Alternatively, the detecting unit 66 can detect the object from the information obtained from a radar (not illustrated), a LIDAR (not illustrated, LIDAR stands for Light Detection and Ranging), or a range image sensor. Thus, there is no restriction on the method for detecting an object from an image, and any known method can be implemented. When an object is detected, the detecting unit 66 sends, to the information processing device 10 via the communication unit 50, the information indicating that an object is detected.

The communication control unit 68 controls the communication unit 50 and thus controls the communication between the imaging device 12 and the external devices. For example, the communication control unit 68 controls the communication between the imaging device 12 and the information processing device 10.

### Operation Details of Information Processing Device

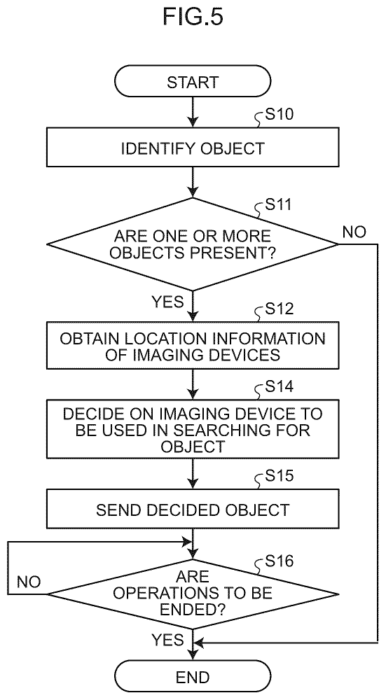

Explained below with reference to FIG. 5 are the operation details of the information processing device according to the first embodiment. FIG. 5 is a flowchart for explaining the operation details of the information processing device according to the first embodiment.

The identifying unit 32 identifies the object that is to be searched using the imaging device 12 (Step S10). Then, the system control proceeds to Step S11.

The identifying unit 32 determines whether or not the number of objects is equal to or greater than one (Step S11). If the number of objects is equal to zero (No at Step S11), the operations illustrated in FIG. 5 are ended. In that case, the operations illustrated in FIG. 5 can be again performed after the elapse of a certain period of time. When the number of objects is equal to or greater than one (Yes at Step S11), the system control proceeds to Step S12.

The location information obtaining unit 60 obtains the current-location information from each imaging device 12 via the communication unit 50 (Step S12). Then, the system control proceeds to Step S14.

The deciding unit 34 decides on the imaging device 12 to be used in searching for the object identified by the identifying unit 32 (Step S14). More particularly, based on the location information of each imaging device 12, the deciding unit 34 decides on the imaging device 12 to be used in searching for the object. For example, the deciding unit 34 extracts all imaging devices 12 located within a predetermined search range as the group of candidate imaging devices 12 to be used in searching for the object. For example, the predetermined range represents, on the map, a circular region having the radius of a few kilometers to a few tens of kilometers or represents, on the map, an administrative area such as an arbitrary city area. However, that is not the only possible case. The size of the search range can be changed according to the type of the object. From the extracted group of candidate imaging devices 12, the deciding unit 34 decides on a smaller number of imaging devices 12 than the total number of candidate imaging devices 12 as the imaging devices 12 to be used in searching for the object. Herein, by reducing the number of imaging devices 12 to be used in searching for the object, the deciding unit 34 can reduce the processing load of the search system 1.

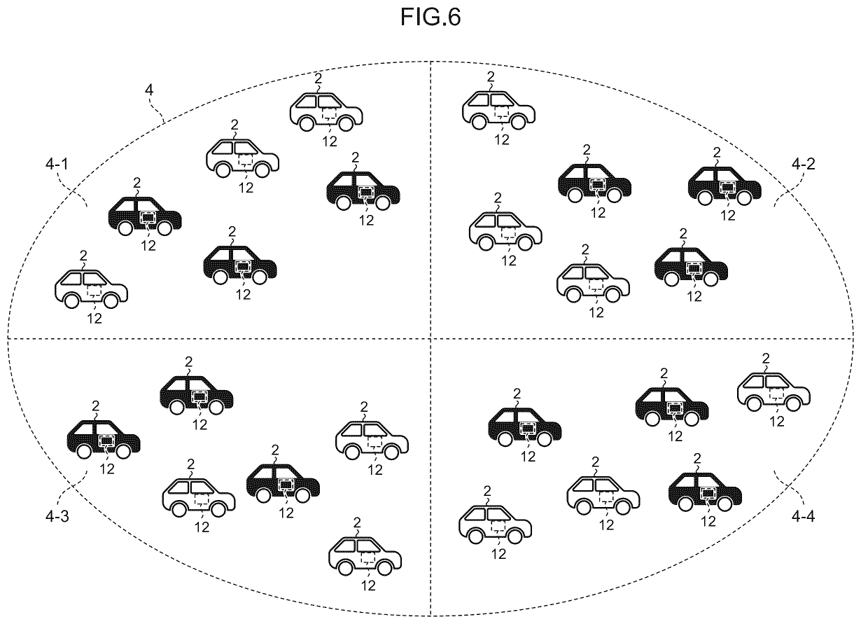

FIG. 6 is a diagram for explaining a method for deciding on the imaging devices 12 to be used in searching for an object according to the first embodiment. More particularly, the deciding unit 34 divides a search range 4 equally into an arbitrary number of regions, and decides on the imaging devices 12, which are to be used in searching for the object, in such a way that, in each region, the same number of imaging devices 12 are used in searching for the object. In the example illustrated in FIG. 6, the deciding unit 34 divides the search range 4 equally into four regions, namely, a search range 4-1, a search range 4-2, a search range 4-3, and a search range 4-4. That is, the deciding unit 34 decides on the imaging devices 12, which are to be used in searching for the object, in such a way that the imaging devices 12 used in searching for the object are located in a dispersed manner within the search range. In the example illustrated in FIG. 6, the vehicles 2 that are dark in color are installed with the imaging device 12 which is to be used in searching for the object; and the vehicles 2 that are light in color are installed with the imaging device 12 which is not to be used in searching for the object. That is, in the example illustrated in FIG. 6, three imaging devices 12 to be used in searching for the object are located in each of the search ranges 4-1 to 4-4.

Meanwhile, the deciding unit 34 need not divide the search range 4 equally into an arbitrary number of regions. Alternatively, for example, based on the number of vehicles 2 per unit area, the search range 4 can be divided into search ranges having different sizes. In that case, the division is done in such a way that, when the number of vehicles 2 per unit area is small, the search range becomes larger; and, when the number of vehicles 2 per unit area is large, the search range becomes smaller.

The communication control unit 36 controls the communication unit 20 and sends the object information, which is related to the object to be searched, to all imaging devices 12 decided by the deciding unit 34 (Step S15). Then, the system control proceeds to Step S16.

The control unit 24 determines whether or not to end the operations (Step S16). For example, when the information indicating that the search is to be ended is received from the information processing device 10, the control unit 24 determines to end the operations. In the case of ending the operations, the communication control unit 36 can send, to all imaging devices 12, the information indicating that the search for the object is to be ended. When it is determined to end the operations (Yes at Step S16), the operations illustrated in FIG. 5 are ended. On the other hand, when it is not determined to end the operations (No at Step S16), the operation at Step S16 is performed again.

### Operation Details of Terminal Device

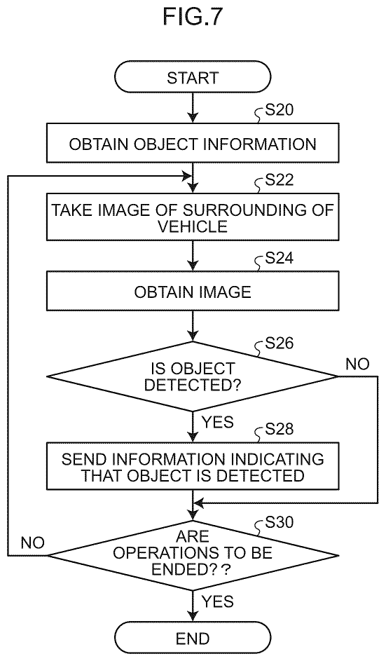

Explained below with reference to FIG. 7 are the operation details of the imaging device according to the first embodiment. FIG. 7 is a flowchart for explaining the operation details of the imaging device according to the first embodiment.

The object information obtaining unit 62 obtains, from the information processing device 10, the object information about the object to be searched (Step S20). Then, the system control proceeds to Step S22.

The imaging control unit 64 controls the imaging unit 42 and causes the imaging unit 42 to take images of the surrounding of the vehicle (Step S22). For example, based on the object information obtained by the object information obtaining unit 62, the imaging control unit 64 can change the direction in which the imaging unit 42 is asked to take images. For example, when a plurality of imaging units 42 is installed corresponding to the imaging directions and when the face information of a person represents the object information, only that imaging unit 42 which takes images of the sidewalk is controlled and images of only the sidewalk are taken. That is, the imaging control unit 64 can control only that imaging unit 42 which takes images in the direction in which the object is assumed to be present, and can instruct that imaging unit 42 to take images. Thus, by reducing the number of imaging units 42 to be controlled, the imaging control unit 64 can reduce the processing load of the imaging devices 12. Moreover, the imaging control unit 64 can control the imaging unit 42 and switch between a visible light camera for daytime imaging and an infrared camera for nighttime imaging. Furthermore, the imaging control unit 64 can control the imaging unit 42 in such a way that, according to the velocity of the vehicle 2, for example, the framerate is lowered when the velocity is low or equal to zero. Then, the system control proceeds to Step S24.

The imaging control unit 64 obtains, from the imaging unit 42, the image taken by the imaging unit 42 (Step S24). Then, the system control proceeds to Step S26.

The detecting unit 66 determines whether or not the object is detected from the image obtained by the imaging control unit 64 (Step S26). When it is determined that the object is detected (Yes at Step S26), the system control proceeds to Step S28. On the other hand, when it is not determined that the object is detected (No at Step S26), the system control proceeds to Step S30.

When the determination result at Step S26 is affirmative, the detecting unit 66 sends, to the information processing device 10, the information indicating that the object is detected (Step S28). For example, the detecting unit 66 sends, to the information processing device 10, the information indicating that the object is detected and the information indicating the position of the detected object. Moreover, the detecting unit 66 can speculate the direction of movement of the object from the direction of the face of the object detected based on the image obtained by the imaging control unit 64, and can further send the information indicating the direction of movement of the object to the information processing device 10. Then, the system control proceeds to Step S30.

Either when the determination result at Step S26 is negative or after the operation at Step S28 is performed, the control unit 54 determines whether or not to end the operations (Step S30). For example, when the information indicating that the search for the object is to be ended is received from the information processing device 10, the control unit 54 determines to end the operations. When it is determined to end the operations (Yes at Step S30), the operations illustrated in FIG. 7 are ended. On the other hand, when it not determined to end the operations (No at Step S30), the system control proceeds to Step S22.

As explained above, in the first embodiment, based on the location information of a plurality of imaging devices 12, the imaging devices 12 to be used in searching for the object are decided. As a result, in the first embodiment, the object can be searched using only specific imaging devices 12 from among a plurality of imaging devices 12. As a result, it becomes possible to reduce the overall processing load of the search system 1.

### Second Embodiment

Given below is the description of a second embodiment. In the second embodiment, an operation is performed in which the imaging devices 12 to be used in searching for the object are changed in a dynamic manner.

### Operation Details of Information Processing Device

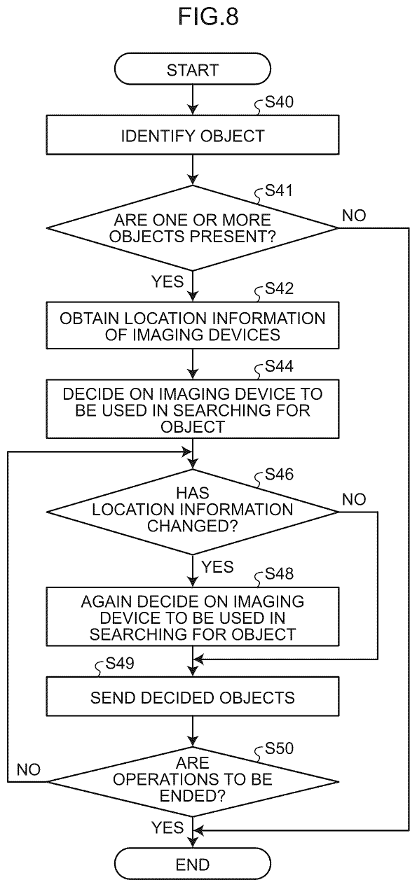

Explained below with reference to FIG. 8 are the operation details of an information processing device according to the second embodiment. FIG. 8 is a flowchart for explaining the operation details of the information processing device according to the second embodiment. The information processing device according to the second embodiment has an identical configuration to the information processing device 10 illustrated in FIG. 3. Hence, that explanation is not given again.

The operations performed from Step S40 to Step S44 are identical to the operations performed from Step S10 to Step S14 illustrated in FIG. 5. Hence, that explanation is not given again.

The location information obtaining unit 60 determines whether or not the current-location information of each imaging device 12 has changed from the previously-obtained location information (Step S46). More particularly, from each imaging device 12, the location information obtaining unit 60 obtains the location information after each predetermined time interval (for example, one minute), and determines whether or not the location information has changed. The predetermined time interval is not limited to one minute, and can be set in an arbitrary manner. When it is determined that the location information of each imaging device 12 has changed (Yes at Step S46), the system control proceeds to Step S48. On the other hand, when it is not determined that the location information of each imaging device 12 has changed (No at Step S46), the system control proceeds to Step S49.

The deciding unit 34 again decides on the imaging devices 12 to be used in searching for the object (Step S48). More particularly, according to the change in the location information of each imaging device 12, the deciding unit 34 again decides on the imaging devices 12 to be used in searching for the object. For example, based on the change in the location information of a plurality of imaging devices 12, the deciding unit 34 can identify the travelling directions of the imaging devices 12; and, according to the travelling directions of the imaging devices 12, can decide on the imaging devices 12 to be used in searching for the object. For example, as the imaging devices 12 to be used in searching for the object, the deciding unit 34 can decide on a plurality of imaging devices 12 moving in the same direction. Alternatively, for example, as the imaging devices 12 to be used in searching for the object, the deciding unit 34 can decide on a plurality of imaging devices 12 moving in different directions. Then, the system control proceeds to Step S49.

The operations performed at Steps S49 and S50 are identical to the operations performed at Steps S15 and S16 illustrated in FIG. 5. Hence, that explanation is not given again.

As explained above, in the second embodiment, based on the change in the location information of a plurality of imaging devices 12, the imaging devices 12 to be used in searching for the object are changed in a dynamic manner. As a result, in the second embodiment, even when there is a change in the location of a plurality of imaging devices 12, the object can be searched using only specific imaging devices 12. Hence, it becomes possible to reduce the overall processing load of the search system 1.

### Third Embodiment

Given below is the description of a third embodiment. In the third embodiment, when the object is a person, after the object has been detected, the imaging devices 12 to be used in searching for the object are dynamically changed so as to be able to track the person on the move.

### Operation Details of Information Processing Device

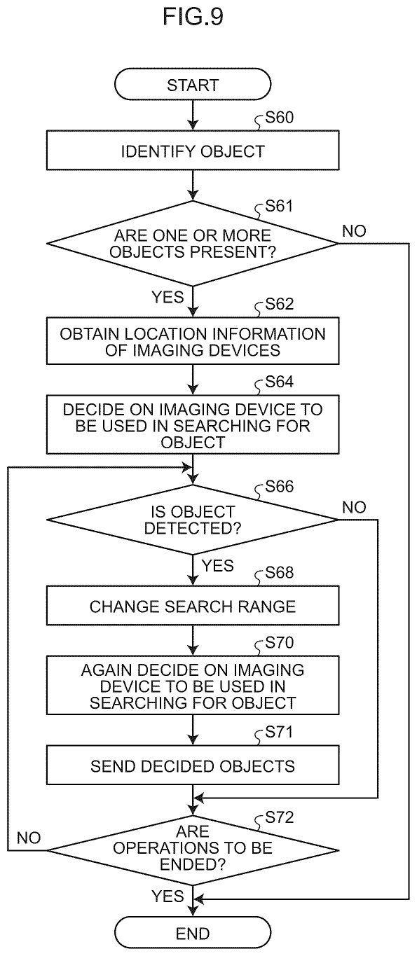

Explained below with reference to FIG. 9 are the operation details of an information processing device according to the third embodiment. FIG. 9 is a flowchart for explaining the operation details of the information processing device according to the third embodiment. The information processing device according to the third embodiment has an identical configuration to the information processing device 10 illustrated in FIG. 3. Hence, that explanation is not given again.

The operations performed from Step S60 to Step S64 are identical to the operations performed from Step S10 to Step S14 illustrated in FIG. 5. Hence, that explanation is not given again.

The control unit 24 determines whether or not the object is detected (Step S66). More particularly, when the information indicating that the object is detected is received from at least one of the imaging devices 12, the control unit 24 determines that the object is detected. When it is determined that the object is detected (Yes at Step S66), the system control proceeds to Step S68. On the other hand, when it is not determined that the object is detected (No at Step S66), the system control proceeds to Step S72.

When the determination result at Step S66 is affirmative, the control unit 24 changes the search range for the object (Step S68). More particularly, based on the location information of the object as received along with the information indicating that the object is detected, the control unit 24 changes the search range for the object. For example, the control unit 24 narrows the predetermined search range around the location at which the object is detected. Then, the system control proceeds to Step S70.

The deciding unit 34 again decides on the imaging devices 12 to be used in searching for the object (Step S70). More particularly, according to the modification in the search range, the deciding unit 34 again decides on the imaging device 12 to be used in searching for the object. For example, from among a plurality of imaging devices 12 located within the modified search range, the deciding unit 34 decides on the imaging devices 12 to be used in searching for the object. Then, the system control proceeds to Step S71.

The operations performed at Steps S71 and S72 are identical to the operations performed at Steps S15 and S16 illustrated in FIG. 5. Hence, that explanation is not given again.

As explained above, in the third embodiment, when the object such as a person is detected, the search range is modified and, and according to the modified search range, the imaging devices 12 to be used in searching for the object are changed in a dynamic manner. As a result, in the third embodiment, it becomes possible to decide the imaging devices 12 to be used in searching for the object while tracking it.

### Fourth Embodiment

Given below is the description of a fourth embodiment. In the fourth embodiment, when a plurality of objects is present as the search targets, the object to be searched by each imaging device 12 is decided in such a way that the processing load of each imaging device 12 is reduced.

### Operation Details of Information Processing Device

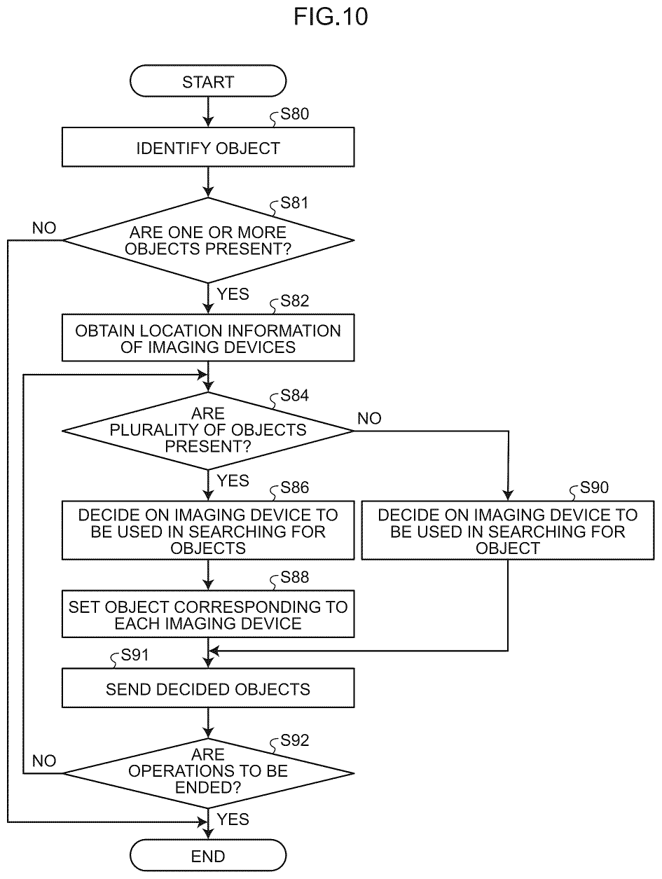

Explained below with reference to FIG. 10 are the operation details of an information processing device according to the fourth embodiment. FIG. 10 is a flowchart for explaining the operation details of the information processing device according to the fourth embodiment.

The operations performed from Step S80 to Step S82 are identical to the operations performed from Step S10 to Step S12 illustrated in FIG. 5. Hence, that explanation is not given again.

The identifying unit 32 identifies whether or not a plurality of objects is present (Step S84). When it is determined that a plurality of objects is present (Yes at Step S84), the system control proceeds to Step S86. On the other hand, when it is not determined that a plurality of objects is present (No at Step S84), the system control proceeds to Step S90.

The operation performed at Step S86 is broadly identical to the operation performed at Step S14 illustrated in FIG. 5. However, as the imaging devices 12 to be used in searching for the object, the deciding unit 34 can decide on all of the imaging devices 12 from among the group of candidate imaging devices 12 extracted at Step S86. That is, all imaging devices 12 located within the predetermined search range can be decided as the imaging devices 12 to be used in searching for the object.

The deciding unit 34 sets, for each imaging device 12, an object representing the search target for that imaging device 12 (Step S88). For example, the deciding unit 34 sets the object for each imaging device 12 in such a way that, within the search range, the imaging devices 12 to be used in searching for a plurality of objects are located in a dispersed manner. For example, the deciding unit 34 performs setting in such a way that, within the search range, the same number of imaging devices 12 are used in searching for each of a plurality of objects.

For example, within the search range, the deciding unit 34 sets only a single object as the search target for each imaging device 12 to be used in searching for an object. Alternatively, the deciding unit 34 can set about two or three objects representing the search targets for each imaging device 12 while ensuring that the processing load of the imaging device 12 does not increase. That is, according to the processing capacity of each imaging device 12, the deciding unit 34 can change the number of objects representing the search targets for that imaging device 12.

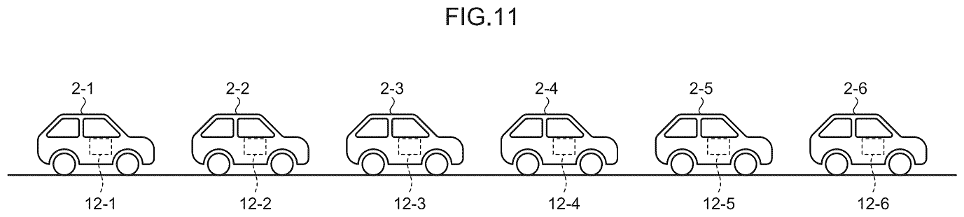

Explained below with reference to FIG. 11 is a method for setting the objects for the imaging devices according to the fourth embodiment. FIG. 11 is a diagram for explaining a method for setting the objects for the imaging devices according to the fourth embodiment. With reference to FIG. 11, the explanation is given for a method in which three objects, namely, an object A, an object B, and an object C are set in the imaging devices.

In FIG. 11, six vehicles, namely, a vehicle 2-1, a vehicle 2-2, a vehicle 2-3, a vehicle 2-4, a vehicle 2-5, and a vehicle 2-6 are illustrated. The vehicles from the vehicle 2-1 to the vehicle 2-6 are located within the search range. The vehicle 2-1 has an imaging device 12-1 installed therein. The vehicle 2-2 has an imaging device 12-2 installed therein. The vehicle 2-3 has an imaging device 12-3 installed therein. The vehicle 2-4 has an imaging device 12-4 installed therein. The vehicle 2-5 has an imaging device 12-5 installed therein. The vehicle 2-6 has an imaging device 12-6 installed therein.

For example, the deciding unit 34 sets an object A as the search target for the imaging device 12-1. Moreover, for example, the deciding unit 34 sets an object B as the search target for the imaging device 12-2. Furthermore, for example, the deciding unit 34 sets an object C as the search target for the imaging device 12-3. Moreover, for example, the deciding unit 34 sets the object A as the search target for the imaging device 12-4. Furthermore, for example, the deciding unit 34 sets the object B as the search target for the imaging device 12-5. Moreover, for example, the deciding unit 34 sets the object C as the search target for the imaging device 12-6.

Thus, when a plurality of objects is present, with respect to each imaging device 12 from the imaging device 12-1 to the imaging device 12-6, the deciding unit 34 sets only one of the objects A to C as the search target, so that there is dispersion in the number of imaging devices 12 searching for each of the objects A to C. At that time, as illustrated in FIG. 11, with respect to each imaging device 12 from the imaging device 12-1 to the imaging device 12-6, the deciding unit 34 can set the search target in such a way that the same number of imaging devices 12 search for each of the objects A to C.

According to the processing capacity of each of the imaging devices 12-1 to 12-6, the deciding unit 34 can change the number of objects placed as the search targets. For example, from among the objects A to C, two or three objects can be set as the search targets for the imaging devices 12 having high processing capacity.

Meanwhile, according to the density of the vehicles 2-1 to 2-6, the deciding unit 34 can change the method for setting the search targets. For example, when the vehicles 2-1 to 2-6 are separated from each other by the distance of 500 meters or more, in order to avoid missing out on the search targets, the deciding unit 34 can set all of the objects A to C as the search targets for each of the imaging devices 12-1 to 12-6. Moreover, when only a small number of vehicles are present per unit area, such as when each of the vehicles 2-1 to 2-6 is present at a place at which the number of vehicles per square kilometer is equal to or smaller than an arbitrary number, the deciding unit 34 can set all of the objects A to C as the search targets for each of the imaging devices 12-1 to 12-6.

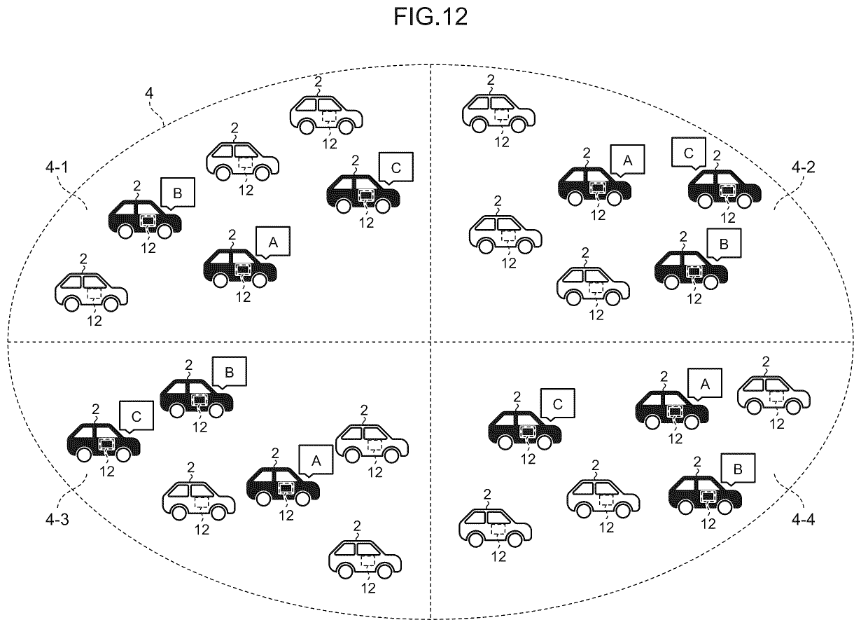

Alternatively, the deciding unit 34 can divide the search range equally into an arbitrary number of regions, and can decide on the imaging devices 12, which are to be used in searching for the objects, in such a way that the same number of imaging devices 12 are used in searching for each of a plurality of objects in each region. FIG. 12 is a diagram for explaining a first method for deciding on the imaging devices 12 to be used in searching for the objects according to the fourth embodiment. In the example illustrated in FIG. 12, in an identical manner to FIG. 6, the vehicles 2 that are dark in color are installed with the imaging device 12 which is to be used in searching for the objects; and the vehicles 2 that are light in color are installed with the imaging device 12 which is not to be used in searching for the objects. The word balloons assigned to the vehicles 2 indicate the object to be searched. Thus, in the example illustrated in FIG. 12, in each of the search ranges 4-1 to 4-4, a single imaging device 12 is present for searching for each of the objects A to C.

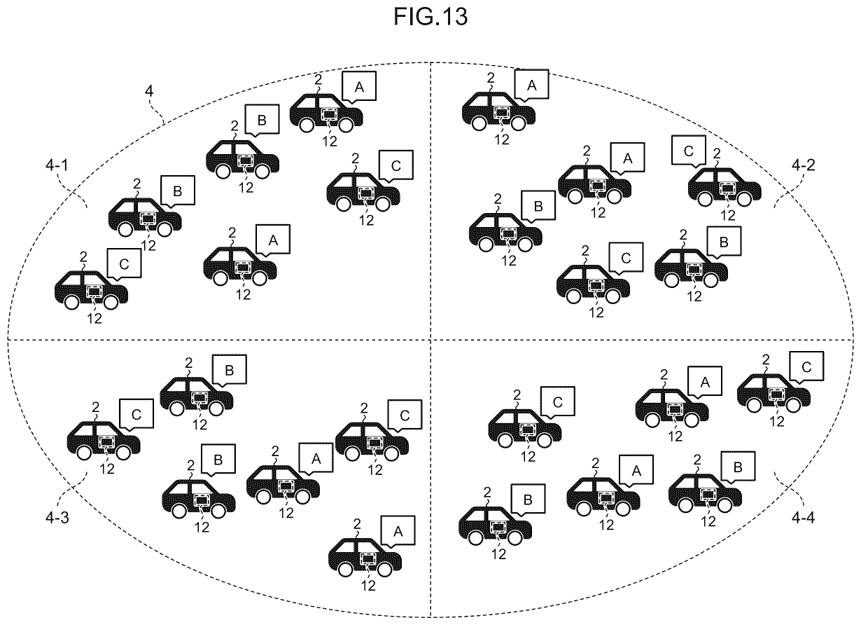

FIG. 13 is a diagram for explaining a second method for deciding on the imaging devices 12 to be used in searching for the objects according to the fourth embodiment. In the example illustrated in FIG. 13, at Step S86 illustrated in FIG. 10, the imaging devices 12 installed in all vehicles present within the search range 4 are decided as the imaging devices to be used in searching for the objects. In an identical manner to FIG. 12, the word balloons assigned to the vehicles 2 indicate the object to be searched for. Thus, in the example illustrated in FIG. 13, in each of the search ranges 4-1 to 4-4, two imaging devices 12 are present for searching for each of the objects A to C.

The operations performed from Step S90 to Step S92 are identical to the operations performed from Step S14 to Step S16 illustrated in FIG. 5. Hence, that explanation is not given again.

As explained above, in the fourth embodiment, when a plurality of objects is present as the search targets, the search targets are set in a dispersed manner across a plurality of imaging devices 12. As a result, in the fourth embodiment, even when a plurality of objects is present as the search targets, it serves the purpose when each imaging device 12 searches for a smaller number of objects than the number of objects set as the search targets for the imaging devices 12. Hence, it becomes possible to reduce the processing load of each imaging device 12 and to reduce the overall processing load of the search system 1.

### Fifth Embodiment

Given below is the description of a fifth embodiment. In the fifth embodiment, when a plurality of objects is present as the search targets, the travelling direction of each of a plurality of imaging devices 12 is taken into account, and the search targets to be assigned to each imaging device 12 are decided in such a way that the processing load of the imaging devices 12 is reduced.

### Operation Details of Information Processing Device

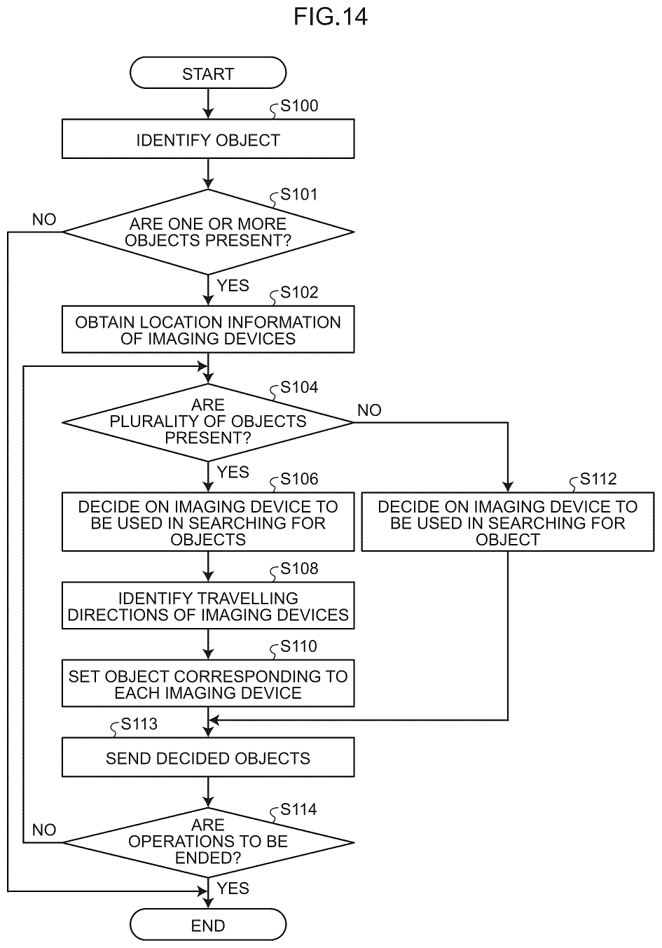

Explained below with reference to FIG. 14 are the operation details of an information processing device according to the fifth embodiment. FIG. 14 is a flowchart for explaining the operation details of the information processing device according to the fifth embodiment.

The operations performed from Step S100 to Step S106 are identical to the operations performed from Step S80 to Step S86 illustrated in FIG. 10. Hence, that explanation is not given again.

The deciding unit 34 identifies the travelling directions of the imaging devices 12 (Step S108). More particularly, based on the change in the location information of each of a plurality of imaging devices 12 as obtained by the location information obtaining unit 60, the deciding unit 34 identifies the travelling direction of each imaging device 12. Then, the system control proceeds to Step S110.

According to the travelling direction of each imaging device 12, the deciding unit 34 sets the objects, which represent the search targets, for that imaging device 12 (Step S110). More particularly, for example, from among a plurality of imaging devices 12, with respect to the imaging devices 12 having the same travelling direction, the same object from among a plurality of objects is set as the search target. As a result of setting the same object as the search target for the imaging devices 12 having the same travelling direction, it becomes possible to improve the search accuracy of the objects. Alternatively, for example, from among a plurality of imaging devices 12, with respect to the imaging devices 12 having the opposite travelling directions, the deciding unit 34 can set the same object as the search target from among a plurality of objects. As a result of setting the same object as the search target for the imaging devices 12 having the opposite travelling directions, it becomes possible to widen the search range for the objects.

The operations performed from Step S112 to Step S114 are identical to the operations performed from Step S14 to Step S16 illustrated in FIG. 5. Hence, that explanation is not given again.

As explained above, in the fifth embodiment, the objects are set as the search targets according to the travelling directions of the imaging devices 12. Hence, in the fifth embodiment, it becomes possible to search for the objects in an appropriate manner.

### Sixth Embodiment

Given below is the description of a sixth embodiment. In the sixth embodiment, based on search information received from an information processing device, an imaging device decides on the object to search for.

### Information Processing Device

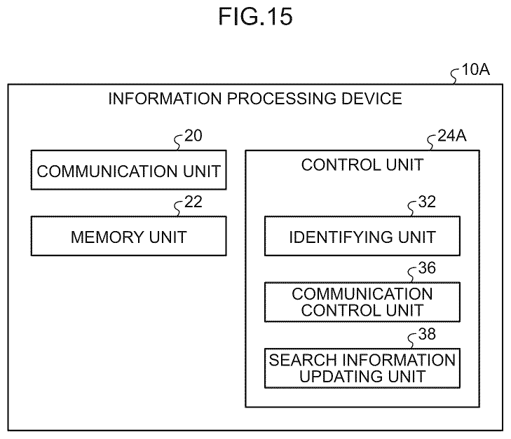

Explained below with reference to FIG. 15 is an exemplary configuration of an information processing device according to the sixth embodiment. FIG. 15 is a diagram for explaining an exemplary configuration of the information processing device according to the sixth embodiment.

An information processing device 10A illustrated in FIG. 15 differs from the information processing device 10, which is illustrated in FIG. 3, in the way of not including the deciding unit 34. In the information processing device 10A, a control unit 24A differs from the information processing device 10, which is illustrated in FIG. 3, in the way of not including the location information obtaining unit 30 but including a search information updating unit 38. The following explanation is given only about the differences with the information processing device 10.

Based on search information indicating the information about the searches as received from the imaging devices 12 via the communication unit 20, the search information updating unit 38 updates the search information. Moreover, the search information updating unit 38 sends the current search information to the imaging devices 12 via the communication unit 20. Herein, for example, the search information contains: the object information related to the objects representing the search targets as identified by the identifying unit 32; and the information about the locations of a plurality of imaging devices 12 searching for the objects. There can be only a single object, or there can be a plurality of objects. Meanwhile, the search information can also contain the information about the search range regarding the objects.

### Imaging Device

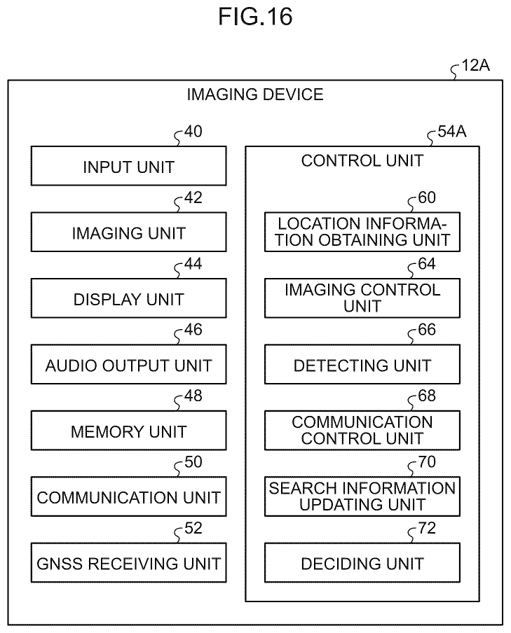

Explained below with reference to FIG. 16 is an exemplary configuration of an imaging device according to the sixth embodiment. FIG. 16 is a block diagram illustrating an exemplary configuration of the imaging device according to the sixth embodiment.

As compared to the imaging device 12 illustrated in FIG. 4, an imaging device 12A illustrated in FIG. 16 differs in the way that a control unit 54A does not include the object information obtaining unit 62 but includes a search information obtaining unit 70 and a deciding unit 72. The following explanation is given only about the differences with the imaging device 12.

The search information obtaining unit 70 obtains the search information, which is the information related to the searches, from the information processing device 10A via the communication unit 50.

Based on the search information obtained from the information processing device 10A, the deciding unit 72 decides on whether to search for the object or, when a plurality of objects is specified in the search information, decides on the objects to be searched. Moreover, based on the location information of each of a plurality of imaging devices 12A as specified in the search information, the deciding unit 72 decides on the imaging devices 12 to be used in searching for the objects. The specific operations performed by the deciding unit 72 for deciding on the objects are same as the operations performed by the deciding unit 34 of the information processing device 10 as illustrated in FIG. 5. Hence, that explanation is not given again.

### Operation Details of Information Processing Device

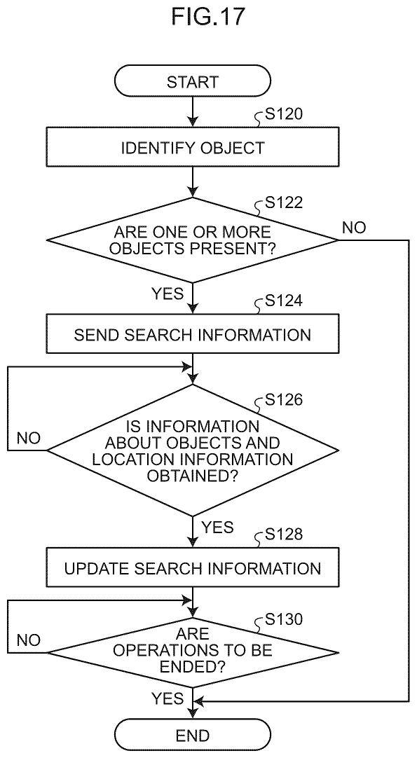

Explained below with reference to FIG. 17 are the operation details of the information processing device according to the sixth embodiment. FIG. 17 is a flowchart for explaining the operation details of the information processing device according to the sixth embodiment.

The operations performed at Steps S120 and S122 are identical to the operations performed at Steps S10 and S11 illustrated in FIG. 5. Hence, that explanation is not given again.

The search information updating unit 38 sends the search information to the imaging devices 12A via the communication unit 20 (Step S124). For example, the search information updating unit 38 sends the search information only to those imaging devices which are located within the search range specified in the search information. Then, the search information updating unit 38 confirms whether or not the information about the decided objects and the location information is obtained from the imaging devices (Step S126). When the information is obtained from the imaging devices (Yes at Step S126), the system control proceeds to Step S128. On the other hand, when the information is not obtained from the imaging devices 12 (No at Step S26), the operation at Step S126 is performed again.

The search information updating unit 38 updates the search information based on the information about the decided objects and the location information as obtained from the imaging devices 12A (Step S128). More particularly, the search information updating unit 38 newly adds, to the search information, the information about the imaging devices 12A that are searching for the objects. The operation performed at Step S130 is identical to the operation performed at Step S16 illustrated in FIG. 5. Hence, that explanation is not given again.

### Operation Details of Terminal Device

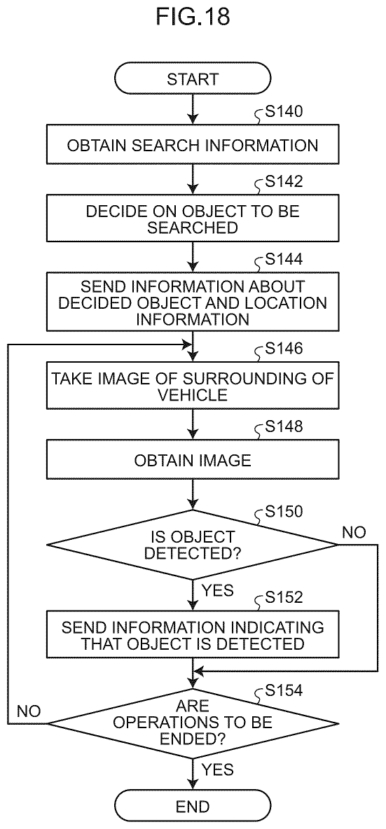

Explained below with reference to FIG. 18 are the operation details of the imaging device according to the sixth embodiment. FIG. 18 is a flowchart for explaining the operation details of the imaging device according to the sixth embodiment.

The search information obtaining unit 70 obtains the search information from the information processing device 10A via the communication unit 50 (Step S140). Then, the system control proceeds to Step S142.

The deciding unit 72 decides on whether or not to search for the objects specified in the search information (Step S142). For example, based on whether or not the concerned imaging device 12A and a plurality of imaging devices 12A specified in the search information are located in a dispersed manner within a predetermined range, the deciding unit 72 decides on whether or not to search for the objects. For example, when a plurality of objects is present, based on whether or not the concerned imaging device 12A and a plurality of imaging devices specified in the search information are located in a dispersed manner, the deciding unit 72 decides on the objects that, from among a plurality of objects, are to be searched.

Herein, the deciding unit 72 can obtain route information from a navigation device (not illustrated) of the vehicle 2 in which the imaging device 12A is installed and, based on the route information, can decide on whether or not to search for the object. For example, when the route information indicates a route heading toward the outside of the search range specified in the search information, the deciding unit 72 decides not to search for the object. That is, whether or not to search for the object is decided based on the travelling direction of the imaging device 12A. Moreover, the deciding unit 72 can decide on whether or not to search for objects according to the processing capacity of the control unit 54A of the imaging device 12A. For example, when the control unit 54A has high processing capacity, the deciding unit 72 decides to search for a greater number of objects. On the other hand, when the control unit 54A has low processing capacity, the deciding unit 72 either decides to search for a smaller number of objects or decides not to search for the objects. As a result, it becomes possible to set an appropriate processing load for the imaging device 12A. Then, the system control proceeds to Step S144.

The deciding unit 72 sends the information about the decided objects and the current-location information of the vehicle 2 to the information processing device 10A via the communication unit 50 (Step S144). The information about the decided objects also contains the information in the case in which there are no decided objects, that is, in the case in which the objects are not to be searched. When the objects are not to be searched, the operations of the flowchart illustrated in FIG. 18 can be ended. Then, the system control proceeds to Step S146.

The operations performed from Step S146 to Step S154 are identical to the operations performed from Step S22 to Step S30 illustrated in FIG. 7. Hence, that explanation is not given again.

As explained above, in the sixth embodiment, based on the search information received from the information processing device, the imaging device decides which objects represent the search targets. Hence, in the sixth embodiment, it becomes possible to optimize the processing load of the imaging device.

The constituent elements of the device illustrated in the drawings are merely conceptual, and need not be physically configured as illustrated. The constituent elements, as a whole or in part, can be separated or integrated either functionally or physically based on various types of loads or use conditions. The configuration based on such separation/integration can be done in a dynamic manner.

Herein, although the application concerned is described with reference to the abovementioned embodiment for a complete and clear disclosure, the appended claims are not to be thus limited but are to be construed as embodying all modifications and alternative constructions that may occur to one skilled in the art that fairly fall within the basic teaching herein set forth. Moreover, the constituent elements explained above can be appropriately combined. Furthermore, the constituent elements can be deleted, substituted, or modified without departing from the scope of the embodiment described above.

The application concerned contributes to the “industry, innovation, and infrastructure” of the SDGs (Sustainable Development Goals), and includes items that contribute in creating values based on IoT solutions.

According to the application concerned, the imaging devices to be used in searching for the search targets can be decided in an appropriate manner, and hence the processing load can be reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
a location information obtaining unit that, from each of a plurality of imaging devices which searches for an object, obtains location information indicating current location of the imaging device; and
a deciding unit that, based on the location information of each of the plurality of imaging devices, decides on the imaging device to be used in searching for the object.

2. The information processing device according to claim 1, wherein the deciding unit decides on imaging devices, which are to be used in searching the object, in such a way that the imaging devices are located in a dispersed manner within a predetermined range.

3. The information processing device according to claim 1, wherein
the deciding unit divides a search range, which represents a range from which a candidate group of the imaging devices to be used in searching for the object is to be extracted, equally into an arbitrary number of regions, and
the imaging devices to be used in searching for the object are decided in such a way that number of the imaging device to be used in searching for the object is equal in each of the arbitrary number of regions.

4. The information processing device according to claim 1, wherein
when a search range, which represents a range from which a candidate group of the imaging devices to be used in searching for the object is to be extracted, is to be divided equally into an arbitrary number of regions, the deciding unit ensures that regions obtained by dividing the search range are large when number of the imaging device per unit area is small and ensures that regions obtained by dividing the search range are small when number of the imaging device per unit area is large, and
the imaging devices to be used in searching for the object are decided in such a way that number of the imaging devices to be used in searching for the object is equal in each of the arbitrary number of regions.

5. The information processing device according to claim 1, wherein, from among imaging devices to be used in searching for the object, when at least a single imaging device detects the object, the deciding unit modifies a search range from which a candidate group of the imaging devices to be used in searching for the object is to be extracted, and
based on modified search range, again decides on an imaging device to be used in searching for the object.

6. The information processing device according to claim 1, wherein, when a plurality of the object is present, the deciding unit sets the objects to be searched by the imaging devices in such a way that the imaging devices to be used in searching for one of the objects are located in a dispersed manner.

7. The information processing device according to claim 6, wherein, based on density of the plurality of imaging devices, the deciding unit decides on a number of the objects, from among the plurality of objects, to be searched by the imaging devices.

8. The information processing device according to claim 1, wherein, based on travelling directions of the plurality of imaging devices, the deciding unit decides on the imaging device to be used in searching for the object.

9. The information processing device according to claim 1, wherein, the location information obtaining unit that, from each of a plurality of imaging devices which is used in a mobile object, obtains location information of the imaging device.

10. An imaging device that is used in a mobile object, comprising:
an imaging unit;
a search information obtaining unit that, from an information processing device, obtains search information containing information related to an object to be searched and location information of imaging devices used in other mobile objects searching for the object;
a deciding unit that, based on the search information, decides on whether or not to search for the object; and
a detecting unit that, from an image taken by the imaging unit, detects the object that is decided to be search target by the deciding unit.

11. The imaging device according to claim 10, wherein, based on the search information and route information of the mobile object, the deciding unit decides on whether or not to search for the object.

12. The imaging device according to claim 10, wherein, based on the search information and level of processing capacity of the detecting unit, the deciding unit decides on whether or not to search for the object.

13. An information processing method comprising:
obtaining, from each of a plurality of imaging devices which searches for an object, location information indicating current location of the imaging device; and
deciding, based on the location information of each of the plurality of imaging devices, the imaging device to be used in searching for the object.
